(19) United States
(12) Patent Application Publication
(10) Pub. No.: US 2005/0023385 A1
(43) Pub. Date: Feb. 3, 2005

(54) Powder robot gun

(76) Inventors: Kui-Chiu Kwok, Gurnee, IL (US); John F. Schaupp, Toledo, OH (US)

Correspondence Address: Lisa M. Soltis;Illinois Tool Works Inc., 3600 West Lake Avenue, Glenview, IL, 60025, US

(21) Appl. No.: 10/628,908

(22) Filed: Jul. 29, 2003

(51) Int. Cl. B05B 1/00

(52) U.S. Cl. 239/589; 239/601

(57) ABSTRACT

A dispenser for dispensing pulverulent coating material includes an opening through which the pulverulent material is discharged and a conduit through which the pulverulent material is transported from a source to the opening. The conduit includes a seal member providing a lumen, a first member including a first reducer section including a lumen and a first feature and a second member including a first expander section including a lumen and a second feature. The first and second features cooperate to define a space for accommodating the seal member between the first reducer section and the first expander section. The conduit further includes a second reducer section and a second expander section.

### FIELD OF THE INVENTION

This invention relates to coating dispensing apparatus. It is disclosed in the context of methods and apparatus for attaching a conduit (hereinafter sometimes a hose) to a fitting in an apparatus (hereinafter sometimes a gun) for dispensing pulverulent coating material (hereinafter sometimes powder) entrained in a stream of transporting gas or mixture of gases, such as air. However, it is believed to be useful in other applications as well.

### BACKGROUND OF THE INVENTION

Various types of apparatus are known for dispensing coatings. There are, for example, the devices illustrated and described in U.S. Pat. Nos. 3,536,514; 3,575,344; 3,698,636; 3,843,054; 3,913,523; 3,964,683; 4,037,561; 4,039,145; 4,114,564; 4,135,667; 4,169,560; 4,216,915; 4,360,155; 4,381,079; 4,447,008; 4,450,785; Re. 31,867; U.S. Pat. Nos. 4,520,754; 4,580,727; 4;598,870; 4,685,620; 4,788,933; 4,798,340; 4,802,625; 4,825,807; 4,921,172; 5,353,995; 5,358,182; 5,433,387; 5,720,436; 5,853,126; and, 6,328,224. There are also the devices illustrated and described in U.S. Pat. Nos. 2,759,763; 2,955,565; 3,102,062; 3,233,655; 3,578,997; 3,589,607; 3,610,528; 3,684,174; 4,066,041; 4,171,100; 4,214,708; 4,215,818; 4,323,197; 4,350,304; 4,402,991; 4,422,577; Re. 31,590; U.S. Pat. Nos. 4,505,430; 4,518,119; 4,726,521; 4,779,805; 4,785,995; 4,879,137; 4,890,190; and, 4,896,384; British Patent Specification 1,209,653; Japanese published patent applications: 62-140,660; 1-315,361; 3-169,361; 3-221,166; 60-151,554; 60-94,166; 63-116,776; 58-124,560; and 331,823 of 1972; and, French patent 1,274,814. There are also the devices illustrated and described in “Aerobell™ Powder Applicator ITW Automatic Division” “Aerobell™ & Aerobell Plus™ Rotary Atomizer, DeVilbiss Ransburg Industrial Liquid Systems,” and ITW GEMA RPG-2 Dual Head Robot Powder Gun Model: 78772.” The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

### DISCLOSURE OF THE INVENTION

According to an aspect of the invention, a dispenser for dispensing pulverulent coating material includes an opening through which the pulverulent material is discharged and a conduit through which the pulverulent material is transported from a source to the opening. The conduit includes a seal member providing a lumen, a first member including a first reducer section including a lumen and a first feature and a second member including a first expander section including a lumen and a second feature. The first and second features cooperate to define a space for accommodating the seal member between the first reducer section and the first expander section.

Illustratively according to this aspect of the invention, the conduit further includes a lumen providing a second reducer section including a lumen, and a second expander section including a lumen.

Illustratively according to this aspect of the invention, the first member is provided in a first structural component and the second member is provided in a second structural component adapted to be selectively coupled to the first structural component. The seal member seals the selective coupling between the first and second structural components.

Additionally illustratively according to this aspect of the invention, the lumen of the first reducer section includes a first cross-sectional area at an outlet end thereof. The lumen of the first expander section includes a second cross-sectional area at an inlet end thereof. The lumen of the seal member provides a transition from the first cross-sectional area to the second cross-sectional area.

Illustratively according to this aspect of the invention, the lumen of the first reducer section includes a first cross-sectional area at an inlet end thereof and a second cross-sectional area at an outlet end thereof. The cross sectional area of the lumen in the first reducer section decreases uniformly from the first cross-sectional area to the second cross-sectional area.

Further illustratively according to this aspect of the invention, the lumen of the first expander section includes a third cross-sectional area at an inlet end thereof and a fourth cross-sectional area at an outlet end thereof. The cross sectional area of the lumen in the first expander section increases uniformly from the third cross-sectional area to the fourth cross-sectional area.

Additionally illustratively according to this aspect of the invention, the lumen of the second reducer section includes a fifth cross-sectional area at an inlet end thereof and a sixth cross-sectional area at an outlet end thereof. The cross sectional area of the lumen in the second reducer section decreases uniformly from the fifth cross-sectional area to the sixth cross-sectional area.

Illustratively according to this aspect of the invention, the lumen of the second expander section includes a seventh cross-sectional area at an inlet end thereof and an eighth cross-sectional area at an outlet end thereof. The cross sectional area of the lumen in the second expander section increases uniformly from the third cross-sectional area to the fourth cross-sectional area.

According to another aspect of the invention, a dispenser for dispensing pulverulent coating material includes an opening through which the pulverulent material is discharged and a conduit through which the pulverulent material is transported from a source to the opening. The conduit includes a first reducer section, a first expander section, a second reducer section, and a second expander section.

Illustratively according to this aspect of the invention, the first reducer section includes a first cross-sectional area at an inlet end thereof and a second cross-sectional area at an outlet end thereof. The cross-sectional area of the first reducer section decreases uniformly from the first cross-sectional area to the second cross-sectional area.

Further illustratively according to this aspect of the invention, the first expander section includes a third cross-sectional area at an inlet end thereof and a fourth cross-sectional area at an outlet end thereof. The cross sectional area of the first expander section increases uniformly from the third cross-sectional area to the fourth cross-sectional area.

Additionally illustratively according to this aspect of the invention, the second reducer section includes a fifth cross-sectional area at an inlet end thereof and a sixth cross-sectional area at an outlet end thereof. The cross sectional area of the second reducer section decreases uniformly from the fifth cross-sectional area to the sixth cross-sectional area.

Illustratively according to this aspect of the invention, the second expander section includes a seventh cross-sectional area at an inlet end thereof and an eighth cross-sectional area at an outlet end thereof. The cross sectional area of the second expander section increases uniformly from the seventh cross-sectional area to the eighth cross-sectional area.

### BRIEF DESCRIPTION OF THE DRAWINGS

The invention may best be understood by referring to the following detailed description and accompanying drawings which illustrate the invention. In the drawings:

FIG. 1 illustrates a partly longitudinal sectional side elevational, partly block diagrammatic view of a system incorporating the invention;

FIG. 2 illustrates a longitudinal sectional side elevational view of a detail of the system illustrated in FIG. 1;

FIG. 3 illustrates an end elevational view of the detail illustrated in FIG. 2, taken generally along the section lines 3-3 of FIG. 2;

FIG. 4 illustrates a longitudinal sectional side elevational view of a detail of the system illustrated in FIG. 1;

FIG. 5 illustrates an end elevational view of the detail illustrated in FIG. 4, taken generally along the section lines 5-5 of FIG. 4;

FIG. 6 illustrates a longitudinal sectional side elevational view of a detail of the system illustrated in FIG. 1;

FIG. 7 illustrates an end elevational view of the detail illustrated in FIG. 6, taken generally along the section lines 7-7 of FIG. 6;

FIG. 8 illustrates a longitudinal sectional side elevational view of a detail of the system illustrated in FIG. 1; and,

FIG. 9 illustrates an end elevational view of the detail illustrated in FIG. 8, taken generally along the section lines 9-9 of FIG. 8.

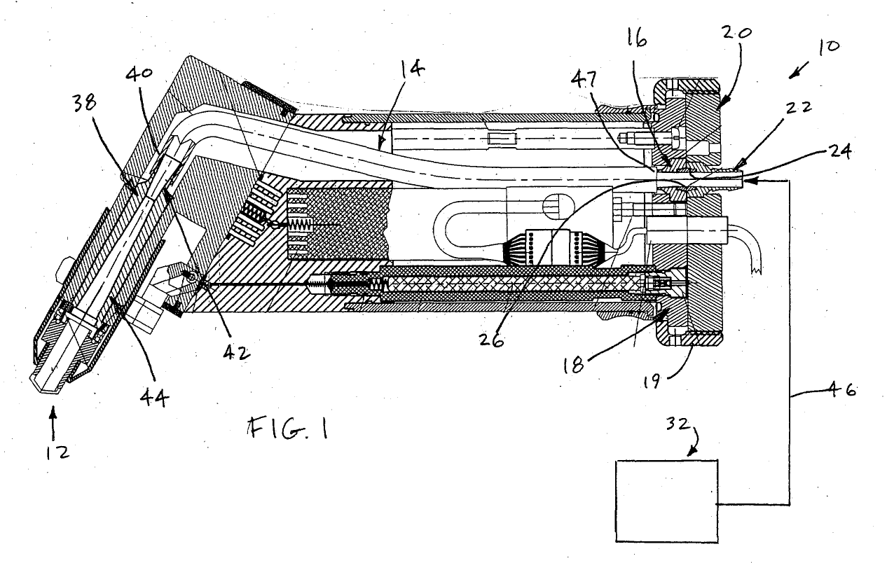

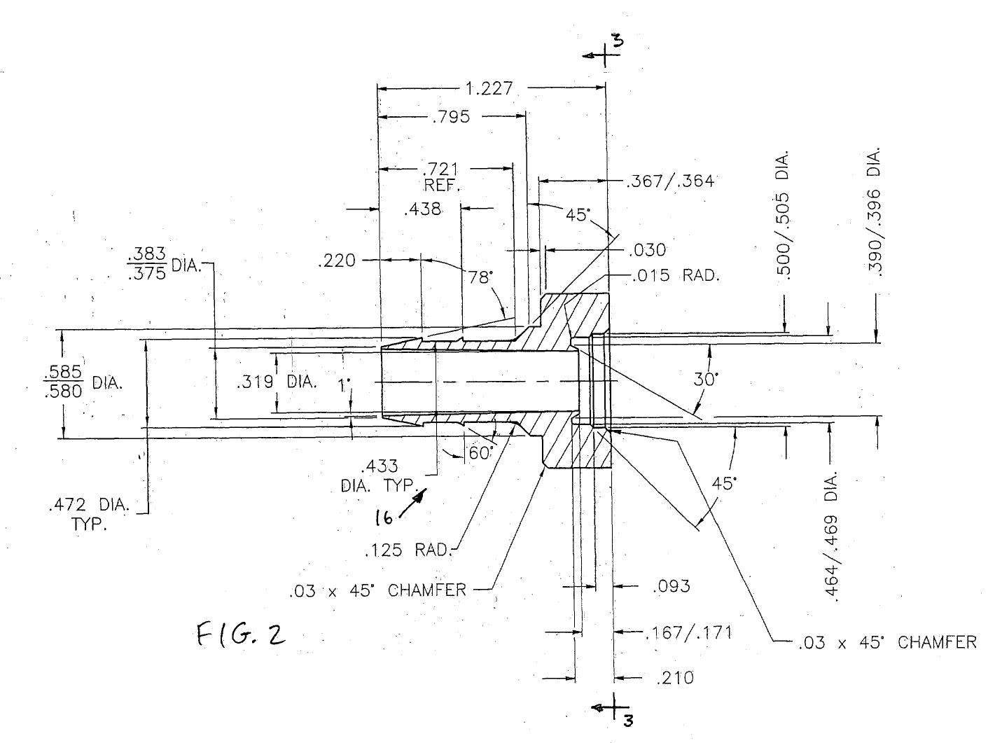

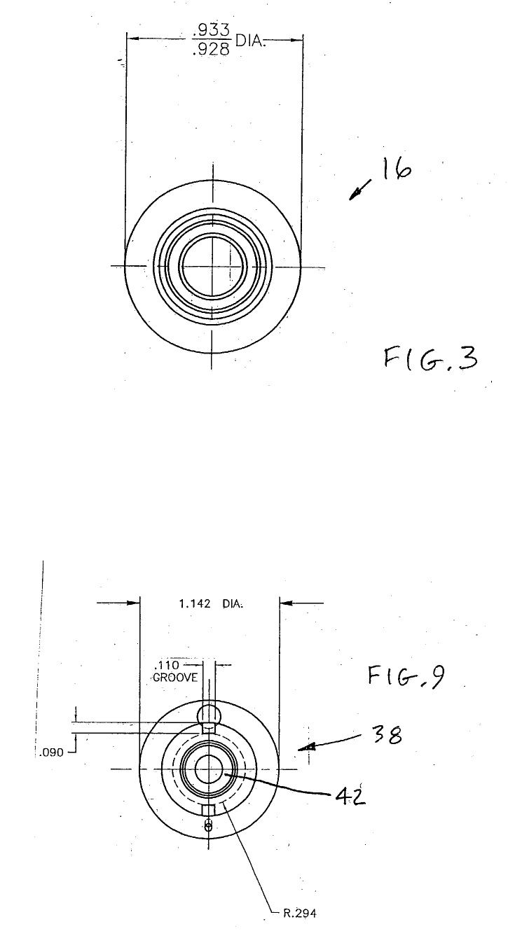

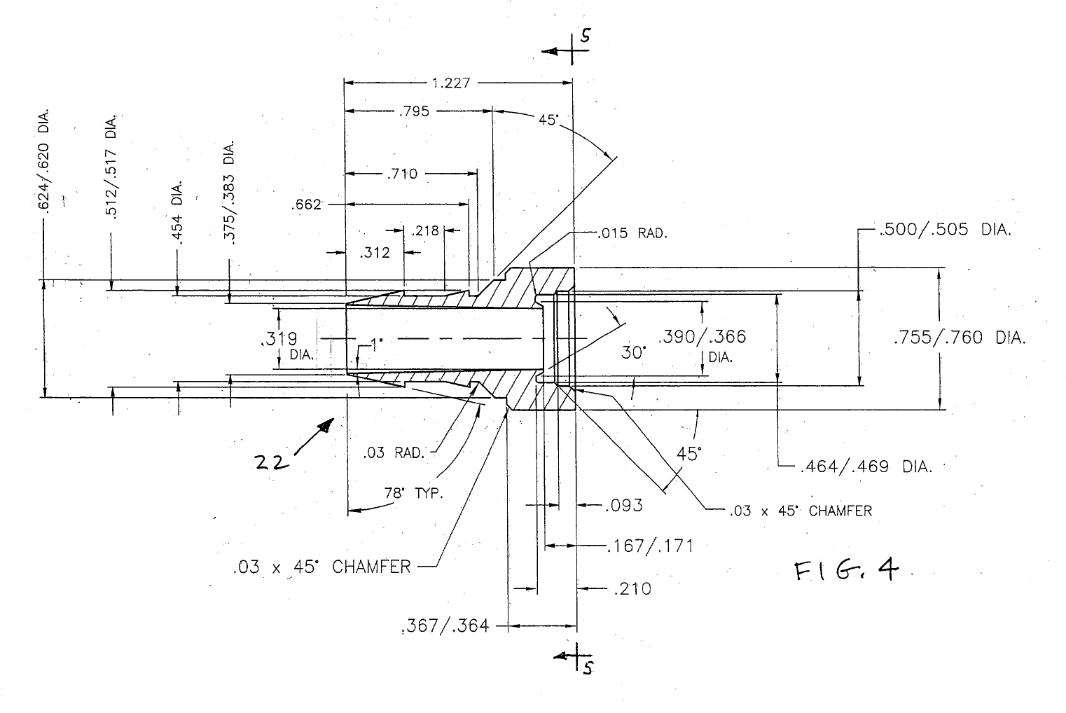

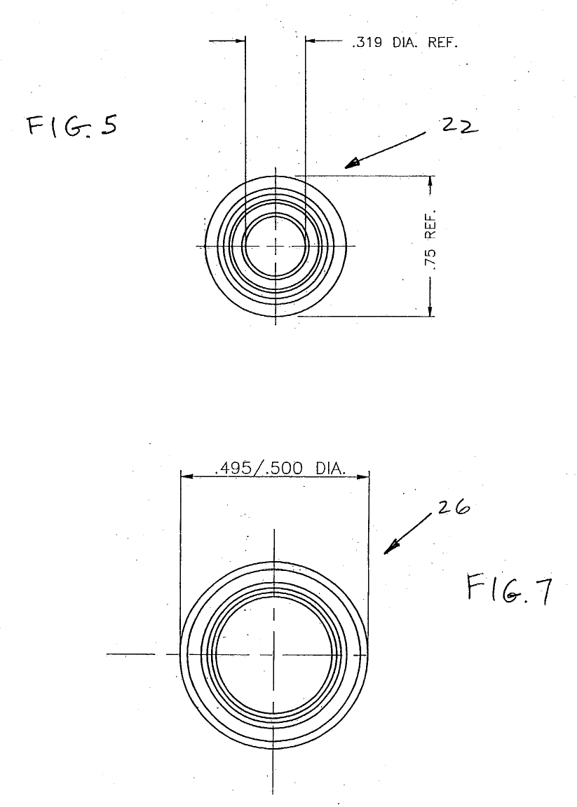

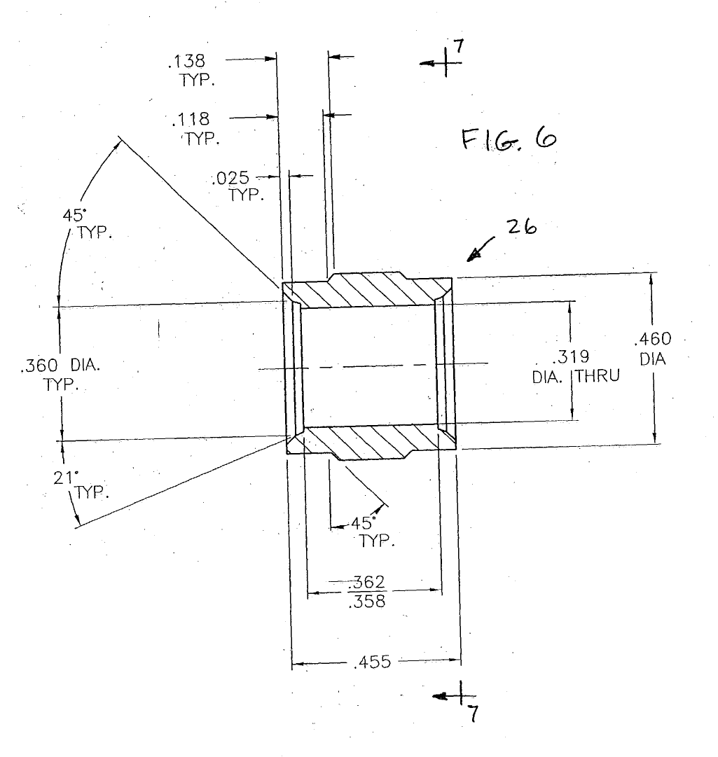

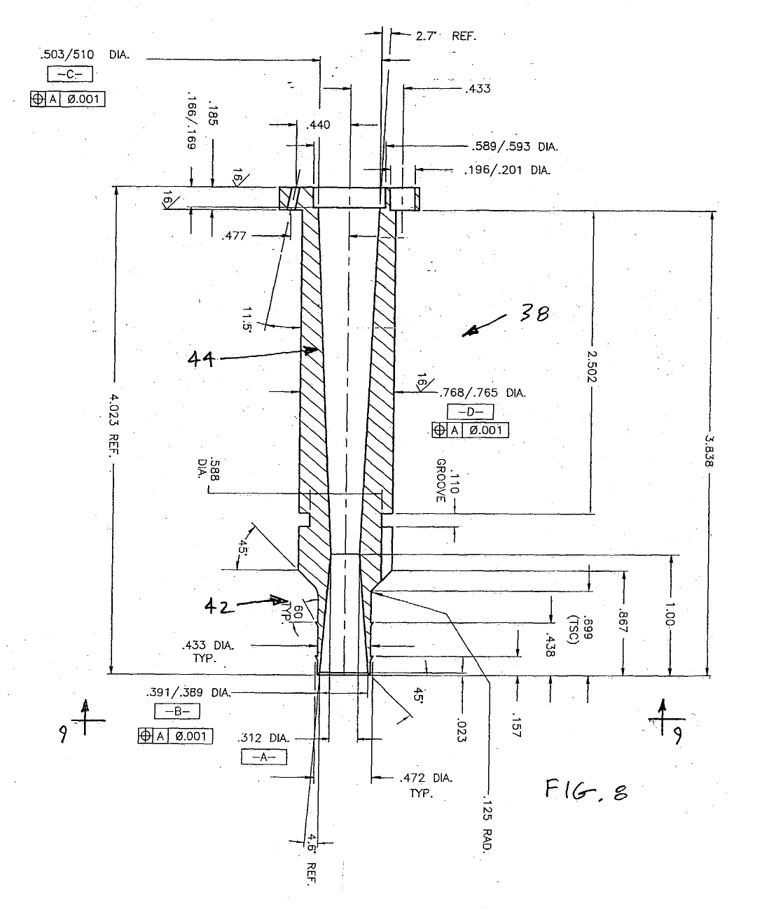

### DETAILED DESCRIPTIONS OF ILLUSTRATIVE EMBODIMENTS

The drawings illustrate a powder gun 10 of the general type of, for example, an RPG-2 dual head robot powder gun model 78772 available from ITW GEMA Automotive Systems, ITW Automotive Finishing Group, 48152 West Road, Wixom, Mich. 48393. Gun 10 includes two side-by-side nozzles 12, each of which is coupled through a respective powder delivery tube 14 to a respective inside-the-gun 10 powder hose barbed fitting 16 mounted in a passageway provided therefor in a robot powder gun rear plate 18. Robot powder gun rear plate 18 is coupled by a threaded robot plate retaining ring 19 to a robot powder gun adapter plate 20 having a mating passageway provided with two robot plate powder hose barbed fittings 22. Each robot plate powder hose barbed fitting 22 cooperates with a respective powder hose barbed fitting 16 to define a groove 24 for receiving a respective powder hose fitting seal 26.

Each robot plate powder hose barbed fitting 22 illustratively includes a lumen which is circular in cross-section transverse to the direction of flow of powder therethrough. The diameter of the circular cross-section decreases linearly from a diameter of about 0.375 inch (about 9.5 mm.) to a diameter of about 0.319 inch (about 8 mm.) over a length of about 1.06 inches (about 2.7 cm.). Each powder hose barbed fitting 16 illustratively includes a lumen which is circular in cross-section. The diameter of the circular cross-section increases linearly from a diameter of about 0.319 inch (about 8 mm.) to a diameter of about 0.375 inch (about 9.5 mm.) over a length of about 1.06 inches (about 2.7 cm.). Fittings 16, 22 illustratively are constructed from 15-20% glass-filled Delrin 570® brand acetal resin. The lumen through seal 26 illustratively has a constant inside diameter of about 0.319 inch (about 8 mm.). Seal 26 illustratively is constructed from low density polyethylene.

This construction provides a low profile seal assembly 22, 26, 16 that results in reduced powder accumulation on and around the seal 26. The seal 26 is nested between the two barbed fittings 16, 22. The fittings 16, 22 cooperate to define the groove 24 which accommodates the seal 26. The seal 26 is compliant. When the seal 26 is oriented between the two barbed fittings 16, 22 and compressed by coupling robot powder gun rear plate 18 and robot powder gun adapter plate 20 together, the seal 26 presents a relatively low profile in the lumen 28 of the powder delivery tube 14, which reduces powder buildup. At the same time, the compression of the seal 26 between the two barbed fittings 16, 22, coupled with the configurations of the lumens of the fittings 16, 22, and the internal dimensions of the seal 26, create a first converging/diverging section in the flow path of the powder from a powder source 32. The source 32 may be one of any of a number of known types such as, for example, a fluidized bed of the general type illustrated and described in U.S. Pat. No. 5,768,800. A powder supply hose 46 extends from powder source 32 through a robot arm (not shown) to the end of which robot powder gun adapter plate 20 is mounted. A proximal end 47 of powder delivery tube 14 is coupled to powder hose barbed fitting 16.

A second flow restrictor 38 is coupled between the remote end 40 of powder delivery tube 14 and nozzle 12. Second flow restrictor 38 includes a reducing section 42 and an expanding section 44. Illustratively, the lumen of reducing section 42 is circular in cross-section. Illustratively, the diameter of the lumen of reducing section 42 decreases linearly from a diameter of about 0.391 inch (about 1 cm.) to a diameter of about 0.312 inch (about 8 mm.) in a length of about 1 inch (about 2.5 cm.). Illustratively, the lumen of expanding section 44 is circular in cross-section. Illustratively, the diameter of the lumen of expanding section 44 increases linearly from the about 0.312 inch (about 8 mm.) diameter to a diameter of about 0.503 inch (about 1.3 cm.) in a length of about 2.834 inches (about 7.2 cm.).

Twists and turns in powder supply hose 46 and powder delivery tube 14 may adversely affect flow parameters of the powder particles suspended in the transporting gas. First and second converging/diverging sections 22, 26, 16 and 42, 44 constrict the flow and then permit the flow to expand at a controlled rate to mitigate such adverse effects on flow parameters. Powder delivery tube 14 illustratively has a length of about 10.25 inches (about 26 cm.) and an inside diameter of about 0.375 inch (about 1 cm.) Powder delivery tube 14 illustratively is constructed from Tygothane® brand polyurethane. Flow restrictor 38 illustratively is constructed from 15-20% glass filled Delrin 570® brand acetat resin.

While the illustrated flow restrictors 16, 22, 26 and 38 have linearly varying reducing and expanding section cross-sectional areas, other configurations are, of course, possible. For example, the longitudinal section of the side wall of one or more of the reducing and/or expanding sections may be other than a straight line. For example, the longitudinal section of the side wall of one or more of the reducing and/or expanding sections may be an exponential curve, parabolic curve, hyperbolic curve, elliptic curve, circular curve, and so on.

1. A dispenser for dispensing pulverulent coating material, the dispenser including an opening through which the pulverulent material is discharged and a conduit through which the pulverulent material is transported from a source to the opening, the conduit including a seal member providing a lumen, a first member including a first reducer section including a lumen and a first feature and a second member including a first expander section including a lumen and a second feature, the first and second features cooperating to define a space for accommodating the seal member between the first reducer section and the first expander section.

2. The apparatus of claim 1 wherein the conduit further includes a lumen providing a second reducer section including a lumen, and a second expander section including a lumen.

3. The apparatus of claim 1 wherein the first member is provided in a first structural component and the second member is provided in a second structural component adapted to be selectively coupled to the first structural component, the seal member sealing the selective coupling between the first and second structural components.

4. The apparatus of claim 1 wherein the lumen of the first reducer section includes a first cross-sectional area at an outlet end thereof, the lumen of the first expander section includes a second cross-sectional area at an inlet end thereof, and the lumen of the seal member provides a transition from the first cross-sectional area to the second cross-sectional area.

5. The apparatus of claim 1 wherein the lumen of the first reducer section includes a first cross-sectional area at an inlet end thereof and a second cross-sectional area at an outlet end thereof, the cross sectional area of the lumen in the first reducer section decreasing uniformly from the first cross-sectional area to the second cross-sectional area.

6. The apparatus of claim 5 wherein the lumen of the first expander section includes a third cross-sectional area at an inlet end thereof and a fourth cross-sectional area at an outlet end thereof, the cross sectional area of the lumen in the first expander section increasing uniformly from the third cross-sectional area to the fourth cross-sectional area.

7. The apparatus of claim 1 wherein the lumen of the first expander section includes a first cross-sectional area at an inlet end thereof and a second cross-sectional area at an outlet end thereof, the cross sectional area of the lumen in the first expander section increasing uniformly (linearly) from the first cross-sectional area to the second cross-sectional area.

8. The apparatus of claim 2 wherein the lumen of the second reducer section includes a first cross-sectional area at an inlet end thereof and a second cross-sectional area at an outlet end thereof, the cross sectional area of the lumen in the second reducer section decreasing uniformly from the first cross-sectional area to the second cross-sectional area.

9. The apparatus of claim 8 wherein the lumen of the second expander section includes a third cross-sectional area at an inlet end thereof and a fourth cross-sectional area at an outlet end thereof, the cross sectional area of the lumen in the second expander section increasing uniformly from the third cross-sectional area to the fourth cross-sectional area.

10. The apparatus of claim 2 wherein the lumen of the second expander section includes a first cross-sectional area at an inlet end thereof and a second cross-sectional area at an outlet end thereof, the cross-sectional area of the lumen in the second expander section increasing uniformly from the first cross-sectional area to the second cross-sectional area.

11. The apparatus of claim 8 wherein the lumen of the first reducer section includes a third cross-sectional area at an inlet end thereof and a fourth cross-sectional area at an outlet end thereof, the cross-sectional area of the lumen of the first reducer section decreasing uniformly from the third cross-sectional area to the fourth cross-sectional area.

12. The apparatus of claim 11 wherein the lumen of the second expander section includes a fifth cross-sectional area at an inlet end thereof and a sixth cross-sectional area at an outlet end thereof, the cross-sectional area of the lumen of the second expander section increasing uniformly from the fifth cross-sectional area to the sixth cross-sectional area.

13. The apparatus of claim 12 wherein the lumen of the first expander section includes a seventh cross-sectional area at an inlet end thereof and an eighth cross-sectional area at an outlet end thereof, the cross-sectional area of the lumen of the first expander section increasing uniformly from the seventh cross-sectional area to the eighth cross-sectional area.

14. A dispenser for dispensing pulverulent coating material, the dispenser including an opening through which the pulverulent material is discharged and a conduit through which the pulverulent material is transported from a source to the opening, the conduit including a first reducer section, a first expander section, a second reducer section, and a second expander section.

15. The apparatus of claim 14 wherein the first reducer section includes a first cross-sectional area at an inlet end thereof and a second cross-sectional area at an outlet end thereof, the cross-sectional area of the first reducer section decreasing uniformly from the first cross-sectional area to the second cross-sectional area.

16. The apparatus of claim 15 wherein the first expander section includes a third cross-sectional area at an inlet end thereof and a fourth cross-sectional area at an outlet end thereof, the cross sectional area of the first expander section increasing uniformly from the third cross-sectional area to the fourth cross-sectional area.

17. The apparatus of claim 14 wherein the first expander section includes a first cross-sectional area at an inlet end thereof and a second cross-sectional area at an outlet end thereof, the cross sectional area of the first expander section increasing uniformly from the first cross-sectional area to the second cross-sectional area.

18. The apparatus of claim 14 wherein the second reducer section includes a first cross-sectional area at an inlet end thereof and a second cross-sectional area at an outlet end thereof, the cross sectional area of the second reducer section decreasing uniformly from the first cross-sectional area to the second cross-sectional area.

19. The apparatus of claim 18 wherein the second expander section includes a third cross-sectional area at an inlet end thereof and a fourth cross-sectional area at an outlet end thereof, the cross sectional area of the second expander section increasing uniformly from the third cross-sectional area to the fourth cross-sectional area.

20. The apparatus of claim 14 wherein the second expander section includes a first cross-sectional area at an inlet end thereof and a second cross-sectional area at an outlet end thereof, the cross sectional area of the second expander section increasing uniformly from the first cross-sectional area to the second cross-sectional area.

21. The apparatus of claim 19 wherein the first reducer section includes a fifth cross-sectional area at an inlet end thereof and a sixth cross-sectional area at an outlet end thereof, the cross-sectional area of the first reducer section decreasing uniformly from the fifth cross-sectional area to the sixth cross-sectional area.

22. The apparatus of claim 21 wherein the first expander section includes a seventh cross-sectional area at an inlet end thereof and an eighth cross-sectional area at an outlet end thereof, the cross-sectional area of the first expander section increasing uniformly from the seventh cross-sectional area to the eighth cross-sectional area.

23. The apparatus of claim 19 wherein the first expander section includes a fifth cross-sectional area at an inlet end thereof and a sixth cross-sectional area at an outlet end thereof, the cross-sectional area of the first expander section increasing uniformly from the fifth cross-sectional area to the sixth cross-sectional area.
